(19) United States
(12) Patent Application Publication
(10) Pub. No.: US 2026/0243263 A1
(43) Pub. Date: Aug. 20, 2026

(54) AXIAL FLOW FAN

(71) Applicant: USUI CO., LTD., Shizuoka (JP)

(72) Inventors: Shinichiro YAMAMOTO, Shizuoka (JP); Yoshinobu IIDA, Shizuoka (JP)

(21) Appl. No.: 19/161,311

(22) PCT Filed: Mar. 19, 2024
(86) PCT No.: PCT/JP2024/010669

§ 371 Date: Sep. 2, 2025

(30) Foreign Application Priority Data
Mar. 20, 2023 (JP) 2023-044237

(51) Int. Cl. F04D 19/00; F04D 29/38

(52) U.S. Cl. CPC F04D 19/002; F04D 29/384

(57) ABSTRACT

Provided is an axial flow fan capable of increasing the air volume between fan blades and thereby improving horsepower efficiency by making improvements in the design of the fan blades to be configured not to perpendicularly receive air flow or wind stream between the fan blades. The axial flow fan has a plurality of fan blades radially extending from the outer periphery of a hub and is characterized by including: a tapered boss with a wide flat surface inclined toward the rotational direction of the fan at a base section of each fan blade on a side facing the rear surface of an adjacent fan blade; and a concave portion curved toward the windward side on an edge of the fan blade on the leeward side.

### RELATED APPLICATIONS

The present application is a National Phase of International Application No. PCT/JP2024/010669, filed Mar. 19, 2024, and claims priority based on Japanese Patent Application No. 2023-044237, filed Mar. 20, 2023.

### TECHNICAL FIELD

The present invention generally relates to an axial flow type engine cooling fan rotationally driven for use in cooling automobile engines and the like. Particularly, the invention relates to the axial flow fan including a plurality of fan blades radially extending on the outer periphery of a hub.

### Background Art

The conventional axial flow fans of such a type have been known as one to have a structure, for example, in which a plurality of fan blades 12 are provided to radially extend from the outer periphery of a hub 11 as shown in FIG. 6 (see PLT 1). In this type of axial flow fan, each fan blade 12 is configured in such a way that a blade side portion 12a with a vertical wall surface is formed integrally with a tapered boss 12b which is formed in a substantially L-shape (sickle-shaped) at a base of the blade body and each blade is integrally provided in a radially extended condition via a blade fixing portion 12c that is fixed at the hub 11 perpendicularly to the shaft, as it is shown to be enlarged in FIG. 4. Furthermore, the conventional axial flow fan is configured to have an angle of approximately 90 degrees between the blade side portion 12 a and an arcuate portion of the blade 12 as shown in FIGS. 4 and 5.

In drawings, a reference sign 12d denotes a blade leading edge, a reference sign 12e denotes a blade trailing edge, a reference sign 13 denotes a mounting member for a mating member, and a reference sign 13a denotes fixing bolt holes.

### CITATION LIST

### Patent Literature

PLT 1: JP 63-025359 Y

### SUMMARY OF INVENTION

### Technical Problem

However, the conventional axial flow fan shown in FIGS. 4 and 5 has the following problems. That is, it has been difficult to form blades of the conventional axial flow fan in FIGS. 4 and 5 by means of normal injection molding due to overlap between the tapered boss 12b and the blade leading edge 12d in formation of the blades. Therefore, the conventional axial flow fan has needed to be configured to prevent the overlap by forming the blade side portion 12a with the vertical wall surface between the tapered boss 12b and the blade leading edge 12d. However, in a case where the blade side portion 12a with the vertical wall surface is formed, there has been a drawback that the vertical wall surface turns out to high resistance to air flow or wind stream therethrough and this leads to a decrease in air volume between the fan blades, thereby reducing horsepower efficiency. Additionally, an angle 0 between the blade side portion 12 a and the blade leading edge 12 d is approximately 2 degrees as shown in FIGS. 4 and 5 and this also causes to the decrease in air volume between the fan blades, thereby inevitably reducing horsepower efficiency. In this regard, the angle θ is generally necessary as a draft angle for resin molding.

The present invention has been made to solve the problems with the conventional axial flow fan, and it provides an axial flow fan capable of increasing air flow between the fan blades and thereby improving horsepower efficiency by making improvements in the design of the fan blades to be configured not to perpendicularly receive air flow or wind stream between the fan blades.

### Solution to Problem

The axial flow fan of the present invention has a plurality of fan blades radially extending from the outer periphery of a hub and it is characterized by including: a tapered boss that has a wide flat surface inclined toward the rotational direction of the fan and is provided on a base section of each fan blade on a side facing the rear surface of an adjacent fan blade; and a concave portion curved toward the windward side on an edge of the fan blade on the leeward side.

Additionally, regarding a taper angle θ of a leading edge at a base portion of the fan blade, the axial flow fan of the present invention is characterized by having the taper angle θ of 2 degrees or more and less than 90 degrees, whereas the conventional axial flow fan has the taper angle θ of approximately 2 degrees.

### Advantageous Effects of Invention

In the axial flow fan according to the present invention, the tapered boss at the base section of each blade is configured to have the wide flat surface inclined toward the direction of fan rotation, and it is therefore possible to reduce significantly to perpendicularly receive air flow or wind stream between the fan blades, thereby providing increased air volume and reducing the cost for additional horsepower. Besides, by setting the taper angle θ of the leading edge at the base portion of the blade to be 2 degrees or more and less than 90 degrees, it ensures that the air flow or wind stream between the fan blades is almost no longer received perpendicularly, thereby resulting in an effective increase in the air volume between the fan blades to further improve the horsepower.

### BRIEF DESCRIPTION OF DRAWINGS

FIG. 1 is an enlarged perspective view of an essential part of an axial flow fan according to an example of the present invention.

FIG. 2 is a perspective view of the fan blade when viewed from the inside of the axial flow fan shown in FIG. 1.

FIG. 3 is an explanatory view illustrating a taper angle of the leading edge at the blade base portion of the axial flow fan shown in FIG. 1.

FIG. 4 is an enlarged perspective view of an essential part of an example of the conventional axial flow fan which is sought to be improved by the present invention.

FIG. 5 is an explanatory view illustrating a taper angle of the leading edge at the blade base portion of the conventional axial flow fan shown in FIG. 4.

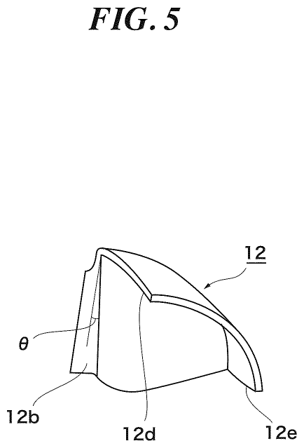

FIG. 6 is a front view of a part of the conventional axial flow fan shown in FIG. 4.

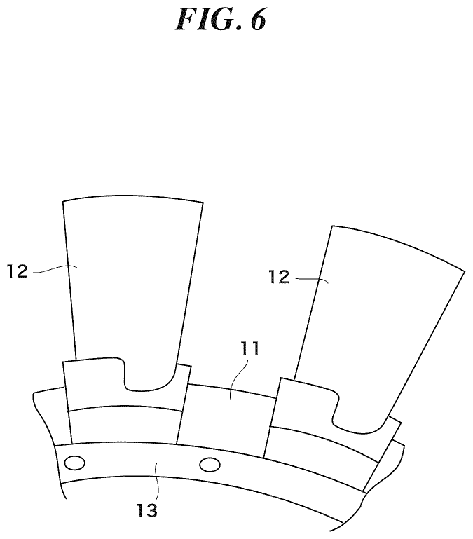

### DESCRIPTION OF EMBODIMENTS

Described below is an example of the axial flow fan according to the present invention.

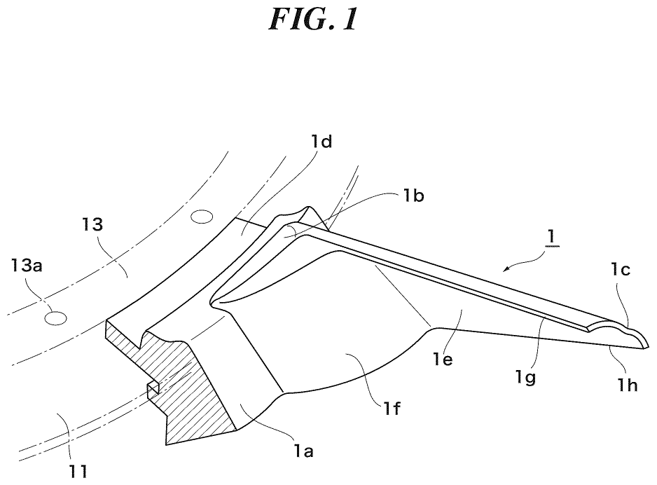

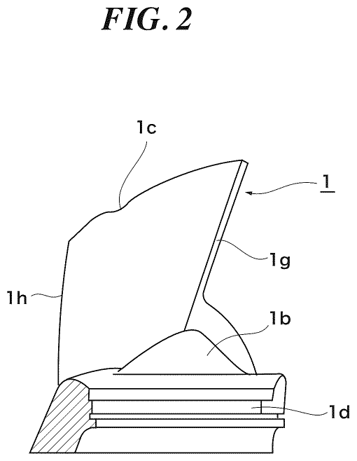

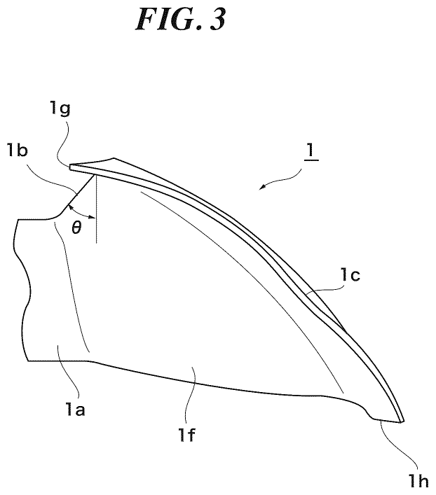

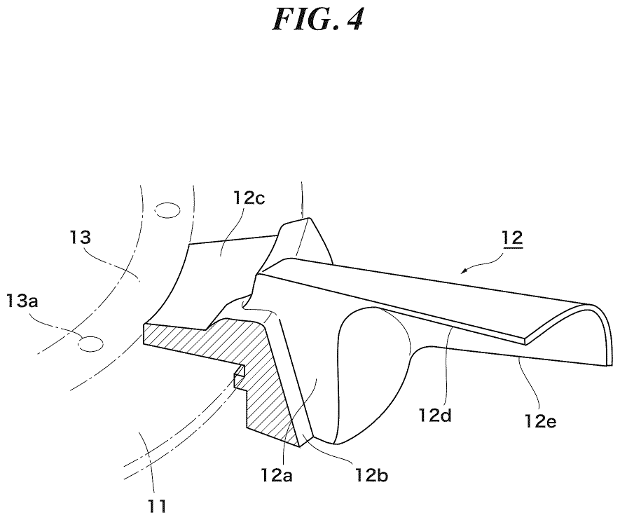

The axial flow fan shown in FIG. 1 has a plurality of fan blades 1 extending radially from the outer periphery of an annular hub 11 that is similar to that of the conventional axial flow fan shown FIG. 4. The features of axial flow fan lie in the followings: a tapered boss 1a having a wide flat surface inclined toward the direction of fan rotation at a base section of each fan blade 1 on the side facing a rear surface of an adjacent blade 1 as shown in FIGS. 1 and 2; the tapered boss la joined to the fan blade 1 by a substantially triangle-shaped blade base portion 1b and an arc-shaped surface 1f of the blade; a concave portion 1c curved toward the windward side at an edge of the blade 1 on the leeward side; and an inclination angle θ of the substantially triangle-shaped blade base portion 1b, namely the taper angle θ of the leading edge at the base portion of the fan blade 1 of 2 degrees or more and less than 90 degrees as shown in FIG. 3. The reason why the taper angle θ of the leading edge at the base portion of the blade 1 is set to be 2 degrees or more and less than 90 degrees is because this makes it less prone to perpendicularly receive air flow or wind stream between the fan blades 1, thereby effectively increasing the air volume between the fan blades to achieve further improvement in horsepower efficiency.

Additionally, the fan blade 1 of the present invention is formed integrally with a blade fixing portion 1d that is provided on the root of the fan blade 1, and it has the structure formed by combining the tapered boss la with the wide flat surface inclined toward the direction of fan rotation, the blade base portion 1b with the oblique face having substantially triangular shape as a junction surface between the tapered boss la and the blade fixing portion 1d, and the arc-shaped surface 1f of the blade formed between the tapered boss 1a and the inner wall surface le of the blade, in addition to the concave portion 1c curved toward the windward side at the edge of the blade 1 on the leeward side. In drawings, a reference sign 1g denotes a blade leading edge and a reference sign 1h denotes a blade trailing edge.

In the axial flow fan of the structure having such a configuration, the fan blade 1, the tapered boss 1a, the blade base portion 1b, the arc-shaped surface 1f of the blade, and the others are integrally formed by injection molding of a resin material, by casting using aluminum or an aluminum alloy material, or the like.

Since in the axial flow fan according to the embodiment shown in FIGS. 1 to 3, the tapered boss la provided on the base section of the fan blade 1 on the side opposing the rear surface of an adjacent blade 1 is formed to have the wide flat surface inclined toward the direction of fan rotation, this significantly reduces the incidence of air flow or wind stream between the fan blades 1 hitting perpendicularly, thereby leading to an increase in air flow and thus resulting in reduction of cost for increasing horsepower. Besides, thanks to the functions of the concave portion 1c curved toward the windward side provided on the edge of the blade 1 on the leeward side and the taper angle θ (2 degrees or more and less than 90 degrees) of the leading edge at the base portion of the blade 1, it makes it possible to increase in air flow between the fan blades and thereby to improve horsepower efficiency.

The experiments conducted by the inventors showed that when the air volume was compared under conditions where the fan was rotated at the same power output (same horsepower) using the axial flow fan of the present invention and the conventional one and then blew air against the same vehicle resistance, the air volume increased by approximately 3 to 4% in the case of using the axial flow fan of the present invention.

1. An axial flow fan having a plurality of fan blades radially extending from an outer periphery of a hub, the axial flow fan comprising
a tapered boss with a wide flat surface inclined toward a rotational direction of the fan at a base section of each fan blade on a side facing a rear surface of an adjacent fan blade, and
a concave portion curved toward a windward side on an edge of the fan blade on a leeward side.

2. The axial flow fan according to claim 1, wherein a taper angle θ of a leading edge at a base portion of the fan blade is 2 degrees or more and less than 90 degrees.
